(19) United States
(12) Patent Application Publication
(10) Pub. No.: US 2024/0403354 A1
(43) Pub. Date: Dec. 5, 2024

(54) ADAPTIVE SUGGESTIONS FOR STICKERS

(71) Applicant: Apple Inc., Cupertino, CA (US)

(72) Inventors: Vignesh JAGADEESH, Saratoga, CA (US); Craig M. FEDERIGHI, Los Altos Hills, CA (US)

(21) Appl. No.: 18/381,105

(22) Filed: Oct. 17, 2023

Related U.S. Application Data
(60) Provisional application No. 63/470,829, filed on Jun. 2, 2023.

(51) Int. Cl. G06F 16/583; G06F 40/30; G06V 20/70

(52) U.S. Cl. CPC G06F 16/583; G06F 40/30; G06V 20/70

(57) ABSTRACT

The subject system may be implemented by at least one processor configured to obtain text input and select an image based on a comparison between the text input and a tag associated with the image. The tag was derived from at least one of the image or a prior use of the image, and the image was extracted from another image. The at least one processor is also configured to provide, responsive to obtaining the text input, the image.

### CROSS-REFERENCE TO RELATED APPLICATIONS

The present application claims the benefit of U.S. Provisional Patent Application Ser. No. 63/470,829, entitled “ADAPTIVE SUGGESTIONS FOR STICKERS,” filed Jun. 2, 2023, which is hereby incorporated herein by reference in its entirety and made part of the present U.S. Utility patent application for all purposes.

### TECHNICAL FIELD

The present description generally relates to digital images and, more particularly, to digital sticker suggestions to facilitate users in searching their digital stickers.

### BACKGROUND

An electronic device such as a laptop, tablet, smartphone, or a wearable device may include a repository for storing images that may be searched by a user to identify one or more stored images.

### BRIEF DESCRIPTION OF THE DRAWINGS

Certain features of the subject technology are set forth in the appended claims. However, for the purpose of explanation, several implementations of the subject technology are set forth in the following figures.

FIG. 1 illustrates an example network environment for digital sticker suggestion, in accordance with one or more implementations.

FIG. 2 depicts an example electronic device that may implement the subject methods and systems, in accordance with one or more implementations.

FIG. 3 depicts a configuration of an electronic device for suggesting digital stickers, in accordance with one or more implementations.

FIG. 4 depicts an electronic device displaying an image from which a digital sticker may be generated, in accordance with one or more implementations.

FIG. 5 depicts an electronic device displaying a set of digital stickers, in accordance with one or more implementations.

FIG. 6 depicts an electronic device displaying digital sticker suggestions, in accordance with one or more implementations.

FIG. 7 depicts a user utilizing a digital sticker in a message transcript on an electronic device, in accordance with one or more implementations.

FIG. 8 depicts a flow diagram of an example process for suggesting digital stickers, in accordance with one or more implementations.

FIG. 9 depicts a flow diagram of another example process for suggesting digital stickers, in accordance with one or more implementations.

FIG. 10 depicts an example electronic system with which aspects of the present disclosure may be implemented, in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

The subject technology is directed to facilitating users in searching through their digital stickers (e.g., digital stickers that they have been generated from images using “subject lifting”, digital stickers that have been downloaded (e.g., from an online store), digital stickers that have been saved from online repositories, digital stickers that have been received from other users, and the like). The subject technology includes at least two approaches to identifying stickers to suggest to a user, for example while a user is typing: a semantic approach and a behavioral approach. In some examples, the behavioral approach may be used as a fallback to the semantic approach since semantic approaches may not have a clear understanding of humor or emotions in images. The subject technology may overcome limitations in computer vision tagging technologies in accurately recognizing or capturing elements related to humor and emotions depicted in visual content, such as images and stickers, by helping elicit meaningful suggestions for the words that users utilize most frequently with stickers.

In the semantic approach, one or more tags may be automatically generated for a sticker via a computer vision process (e.g., image/object recognition). For example, if the sticker is or includes a dog, the tag may include ‘dog’ and/or the breed of dog. The tags may be stored as metadata in a semantic mapping table along with an associated sticker identifier. Stickers may be suggested by receiving a text input from the user (e.g., via a keyboard) and comparing the text input to the semantic mapping table to identify relevant sticker suggestions. In some examples, the text input may be mapped to an embedding and compared with an embedding of the sticker in an embedding space that is shared by images and language (e.g., text) to allow for fuzzy matching rather than direct string matching. For example, stickers associated with sticker/image embeddings that are within a threshold distance from the embedding corresponding to the text input in an embedding space may be suggested to the user.

In the behavioral approach, auxiliary metadata may be generated to capture the context around the usage of the sticker. This metadata may include information such as the application (or “app”) in which the sticker was used and/or contextual words that can potentially indicate the mood of the sticker. For example, certain stickers may be used in association with words like “LOL,” “haha,” “cute,” or other words associated with emojis. The subject technology uses these contextual words to associate specific stickers with particular moods or emotions. Similar to the metadata in the semantic mapping table, the auxiliary metadata may be stored in a behavior mapping table along with an associated sticker identifier.

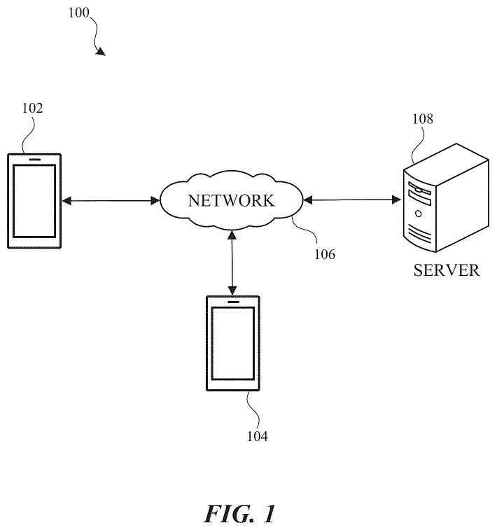

FIG. 1 illustrates an example network environment 100 for digital sticker suggestion, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 may include an electronic device 102, an electronic device 104, and one or more servers (e.g., a server 108). The network 106 may communicatively (directly or indirectly) couple the electronic device 102, the electronic device 104, and/or the server 108. In one or more implementations, the network 106 may be an interconnected network of devices that may include, or may be communicatively coupled to, the Internet. For explanatory purposes, the network environment 100 is illustrated in FIG. 1 as including the electronic device 102, the electronic device 104, and the server 108; however, the network environment 100 may include any number of electronic devices and/or any number of servers communicatively coupled to each other directly and/or via the network 106.

Aspects of the subject technology include communication of image data (e.g., photos, digital stickers, and the like) between electronic devices (e.g., electronic device 102 and/or electronic device 104). With the image data, an electronic device (e.g., electronic device 102 and/or electronic device 104) may generate a repository of digital stickers from which a user of the electronic device may search to use one or more digital stickers. Although aspects of the subject technology are discussed with regard to digital stickers, it should be understood that the subject technology is not limited to digital stickers but may also be applied to any form of image for which semantic data (e.g., tags) and/or contextual data (e.g., an application in which the image was used, context regarding a messaging thread in which the image was used, etc.) may be generated.

The electronic device 102 may be, for example, a desktop computer, a portable computing device such as a laptop computer, a smartphone, a peripheral device (e.g., a digital camera, headphones), a tablet device, a wearable device (e.g., a watch, a band, and the like), or any other appropriate device that includes, for example, one or more wireless interfaces, such as WLAN radios, cellular radios, Bluetooth radios, Zigbee radios, near field communication (NFC) radios, and/or other wireless radios. In one or more implementations, the electronic device 102 may include a campaign client module (and/or circuitry) and one or more applications capable of presenting advertisements. In FIG. 1, by way of example, the electronic device 102 is depicted as a smartphone.

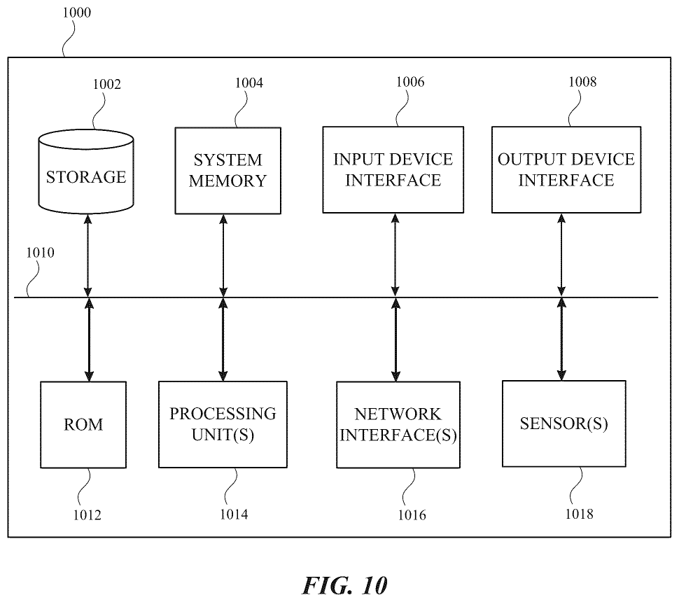

The electronic device 102 may be, and/or may include all or part of, the electronic system discussed below with respect to FIG. 10. In one or more implementations, the electronic device 102 may include an electronic display (e.g., a touchscreen) with which a user may interact with a digital keyboard and/or a digital sticker. For example, to interact with a digital keyboard, the user may press (e.g., touch-down and/or touch-up input on the touchscreen) on one or more elements of the digital keyboard corresponding to one or more letters to form one or more words. During and/or following interacting with the digital keyboard, the electronic device 102 may suggest one or more digital stickers. To interact with a digital sticker, the user may press and hold (e.g., touch-down input on the touchscreen) on the digital sticker to “peel” the digital sticker from one location on the touchscreen and drag and release (e.g., drag and touch-up input on the touchscreen) to “stick” the digital sticker in another location on the touchscreen.

The electronic device 104 may be, for example, a portable computing device such as a laptop computer, a smartphone, a peripheral device (e.g., a digital camera, headphones), a tablet device, a wearable device such as a watch, a band, and the like, any other appropriate device that includes, for example, one or more wireless interfaces, such as WLAN radios, cellular radios, Bluetooth radios, Zigbee radios, NFC radios, and/or other wireless radios. In FIG. 1, by way of example, the electronic device 104 is depicted as a smartphone. The electronic device 104 may be, and/or may include all or part of, the electronic system discussed below with respect to FIG. 10.

In one or more implementations, one or more servers such as the server 108 may perform operations for managing the secure exchange of communications data and/or communications sessions data between various electronic devices such as the electronic device 102 and/or the electronic device 104, such as during a group communications session (e.g., a text messaging session). In some variations, the server 108 is a relay server (e.g., a quick relay server). In some variations, the server 108 includes one or more app-specific modules (e.g., plugins) that perform operations for a respective application. In some variations, the server 108 includes one or more push modules for providing asynchronous notifications to one or more electronic devices (e.g., publish-subscribe messaging).

In one or more implementations, the server 108 may also or instead store account information (e.g., account, handles, or any other account-specific data) associated with the electronic device 102 and/or the electronic device 104, and/or users of those devices.

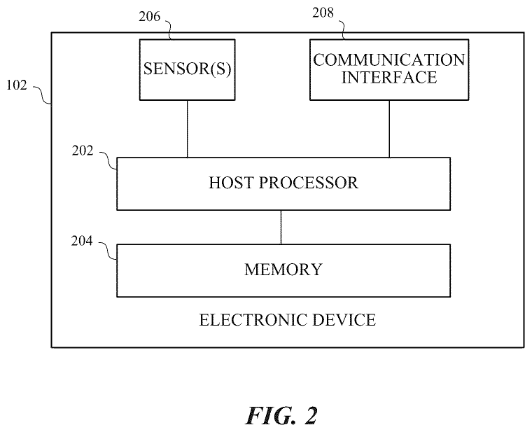

FIG. 2 depicts an example electronic device 102 that may implement the subject methods and systems, in accordance with one or more implementations. For explanatory purposes, FIG. 2 is primarily described herein with reference to the electronic device 102 of FIG. 1. However, this is merely illustrative, and features of the electronic device of FIG. 2 may be implemented in any other electronic device for implementing the subject technology. Not all of the depicted components may be used in all implementations, however, and one or more implementations may include additional or different components than those shown in FIG. 2. Variations in the arrangement and type of the components may be made without departing from the spirit or scope of the claims as set forth herein. Additional components, different components, or fewer components may be provided.

The electronic device 102 may include one or more of a host processor 202, a memory 204, one or more sensor(s) 206, and/or a communication interface 208. The host processor 202 may include suitable logic, circuitry, and/or code that enable processing data and/or controlling operations of the electronic device 102. In this regard, the host processor 202 may be enabled to provide control signals to various other components of the electronic device 102. The host processor 202 may also control transfers of data between various portions of the electronic device 102. The host processor 202 may further implement an operating system or may otherwise execute code to manage operations of the electronic device 102.

The memory 204 may include suitable logic, circuitry, and/or code that enable storage of various types of information such as received data, generated data, code, and/or configuration information. The memory 204 may include volatile memory (e.g., random access memory (RAM)) and/or non-volatile memory (e.g., read-only memory (ROM), flash, and/or magnetic storage). In one or more implementations, the memory 204 may store user location data, images (e.g., photos, digital stickers, and the like), semantic data (e.g., image tags, semantic indexes, and the like) behavioral data (e.g., user interactions, recently used applications, behavior indexes, and the like), account data (e.g., login information, user IDs, and the like), and any other data generated in the course of performing the processes described herein.

The sensor(s) 206 may include one or more microphones and/or image sensors. The microphones may be used to facilitate the text input to an application by a user via, for example, a speech-to-text interface. The image sensors may be used to capture images from which one or more digital stickers may be generated via, for example, image segmentation.

The communication interface 208 may include suitable logic, circuitry, and/or code that enables wired or wireless communication, such as between the electronic device 102 and the server 108. The communication interface 208 may include, for example, one or more of a Bluetooth communication interface, an NFC interface, a Zigbee communication interface, a WLAN communication interface, a USB communication interface, a cellular interface, or generally any communication interface.

In one or more implementations, one or more of the host processor 202, the memory 204, the sensor(s) 206, the communication interface 208, and/or one or more portions thereof may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

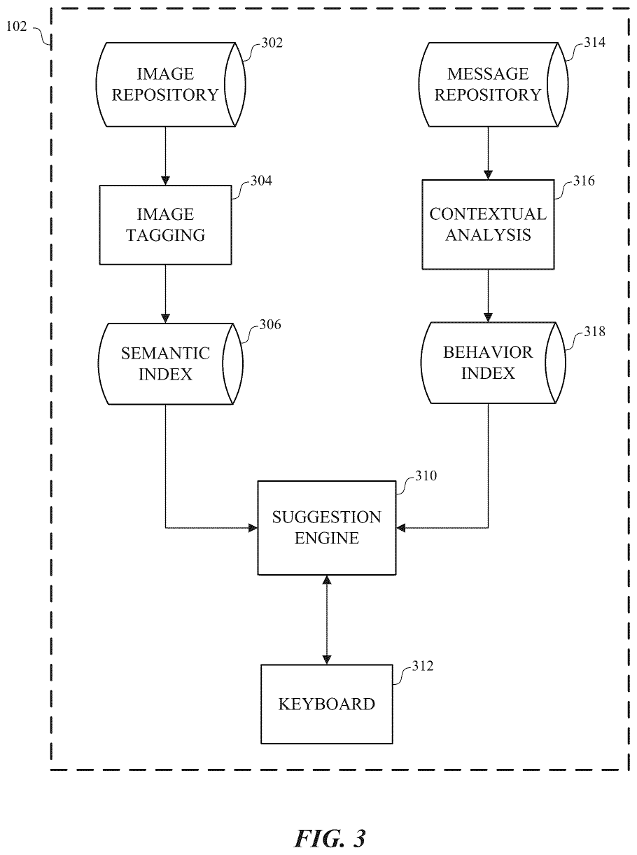

FIG. 3 depicts a configuration of an electronic device for suggesting digital stickers, in accordance with one or more implementations. For explanatory purposes, FIG. 3 is primarily described herein with reference to the electronic device 102 of FIG. 1. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

For the semantic approach for sticker suggestions, the electronic device 102 may include an image repository 302. The image repository 302 may be stored in memory 204 and may be a database, library, and/or any other kind of data structure for storing one or more images (e.g., photos, stickers, and the like) in any format (e.g., JPEG, PNG, GIF, BMP, and the like). For example, the image repository 302 may store one or more digital stickers that the user has created using “subject lifting,” where the electronic device 102 extracts (e.g., responsive to a user selection) a subject from an image to create a second image (e.g., a digital sticker) of the subject.

The electronic device 102 may perform image tagging 304 on one or more of the images in the image repository. Generating tags from an image may involve computer vision and/or other machine learning technology, such as image recognition or object detection algorithms. The electronic device 102 may process the image, identifying key subjects and elements, and assign appropriate tags based on its findings. For example, assume a user generates a digital sticker from an image of a Golden Retriever dog in a park. The electronic device 102, using an image recognition algorithm, would analyze the digital sticker and identify a dog, specifically a Golden Retriever, due to its distinct features and shape, which would result in tags such as “dog” and/or “Golden Retriever” being associated with the sticker, and/or one or more synonyms for “dog,” such as “puppy,” “animal,” “pet,” etc. In some examples, the image recognition algorithm may also generate tags based on text associated with the image. For example, identifying a dog with a collar may return tags including the name on a tag of the collar, words on the collar (e.g., “service animal”), etc.

The electronic device 102 may also include a semantic index. The semantic index 306 may also be stored in memory 204 and may serve as a catalog of tags associated with one or more images. The tags may be stored in the semantic index 306 in association with their corresponding image(s). For example, an entry in the semantic index 306 may include a set of tags indexed by an identifier (e.g., file name, hash, file location, and the like) associated with the image from which the tag was generated. In one or more implementations, the memory 204 may further store a synonym index that may be used to expand the tags associated with a given image. For example, the synonym index may store the term “dog” in association with one or more synonyms for “dog,” such as “puppy.”

For the semantic approach for sticker suggestions, the electronic device 102 may include a message repository 314. The message repository 314 may include a database, library, and/or any other kind of data structure for locally storing the user's messages from one or more messaging applications. Each entry in the message repository 314 may correspond to one or more messages and may include, for example, the content of the message (e.g., text and any media, such as stickers), metadata (e.g., the source application, sender and receiver information, timestamp, and the like), and/or any associated contextual data (e.g., emojis used, preceding or succeeding messages, and the like). The message repository 314 may continually update as new messages are received or sent in any of the user's messaging applications.

The electronic device 102 may perform contextual analysis 316 of one or more messages stored in the message repository. Contextual analysis aims to understand the context in which stickers are used and generate auxiliary metadata that captures this context. The electronic device 102 may review the content of a message transcript (e.g., conversation) leading up to and following a usage of a digital sticker and identify features such as emotive words and phrases (e.g., “haha,” “OMG”, and the like), the time of the messages (e.g., conversations late at night might have a different mood than those in the morning), the other participant(s) in the message transcript, and/or the application in which the digital sticker was used. After analysis, the system generates auxiliary metadata that encapsulates this context. For instance, when a user sends a sticker featuring a laughing dog in a conversation where the word “LOL” was used multiple times, the electronic device 102 examines the conversation, noting that the laughing dog sticker was used in a humorous context (e.g., with “LOL”) in the messaging application.

The electronic device 102 may also include a behavior index. The behavior index 318 may also be stored in memory 204 and may serve as a catalog of auxiliary metadata associated with one or more images. The auxiliary metadata may be stored in the behavior index 318 in association with their corresponding image(s). For example, an entry in the behavior index 318 may include a set of auxiliary metadata indexed by an identifier associated with the image whose usage(s) were the basis for generating the auxiliary metadata.

For applying either or both approaches, the electronic device 102 may obtain (e.g., receive, download, access, and the like) a text input. The text input may be obtained via a keyboard 312 of the electronic device 102, such as a virtual keyboard that the user may interact with via a touchscreen of the electronic device 102. In some examples, the keyboard 312 is a predictive keyboard that provides suggestions to the user as the user is typing text input. For example, a user may enter a word or partial word and the predictive keyboard may suggest a word related to the word or partial word and/or a digital sticker related to the word or partial word.

With the text input, the suggestion engine 310 may select one or more images based on a comparison between at least some of the text input and a tag and/or metadata associated with the image. The suggestion engine 310 may refer to a software application or system that provides personalized recommendations or suggestions to users based on their preferences, behavior, contextual information, and the like. In some examples, the suggestion engine 310 may compare at least some of the text input with the tags stored in the semantic index. Partial or complete matches between the text input and a tag may cause the suggestion engine 310 to obtain the image identifier associated with the tag, which the suggestion engine 310 may use to retrieve the image (e.g., from the image repository 302). In some examples, the suggestion engine 310 may compare at least some of the text input with the metadata stored in the behavior index. Partial or complete matches between the text input and a particular metadata may cause the suggestion engine 310 to obtain the image identifier associated with the metadata, which the suggestion engine 310 may use to retrieve the image (e.g., from the image repository 302). With the images, the suggestion engine 310 may provide (e.g., display, notify, prompt, and the like) one or more of the images to the user. For example, the text input may be to a search bar and the suggestion engine 310 may provide a suggested image for display in a search results list. As another example, the text input may be to a predictive keyboard and the suggestion engine 310 provides a suggested image for display on the predictive keyboard.

In some examples, before the suggestion engine 310 provides one or more images, the suggestion engine 310 may sort, filter, or otherwise modify the one or more images. For example, the suggestion engine 310 sorts the one or more images based on their usage and/or based on how recently they were used. As another example, the suggestion engine 310 filters the one or more images to only the first three images, or the first N images, where N is any number.

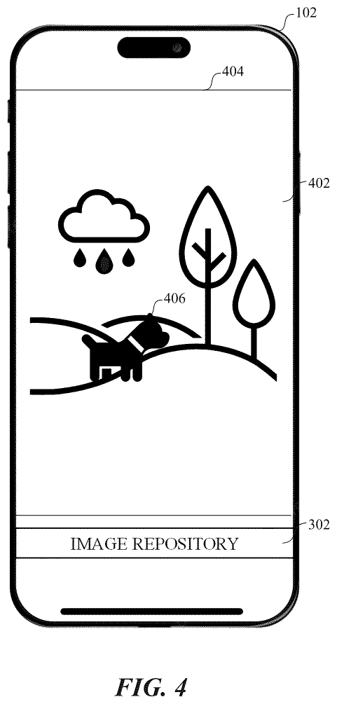

FIG. 4 depicts an electronic device displaying an image from which a digital sticker may be generated, in accordance with one or more implementations. For explanatory purposes, FIG. 4 is primarily described herein with reference to the electronic device 102 of FIG. 1. Not all of the depicted components may be used in all implementations, however, and one or more implementations may include additional or different components than those shown in the figure.

The electronic device 102 may include an image repository 302 including one or more images. The image repository 302 may be managed by, and/or included in, an application on the electronic device 102, such as a photo app. A first image 404 may be selected from the image repository 302 for display on the electronic device. The first image 404 may include a subject 406 and a background 402. As shown in FIG. 4 the subject 406 is a dog and the background 402 is a field with trees. The electronic device 102 may generate a second image (e.g., a sticker) from the first image 404 by extracting (e.g., lifting) the subject 406 from the first image 404 and generating the second image from the extracted subject. For example, a user may select the subject 406, such as by touching the subject 406, and the electronic device 102 may “lift,” or segment, the subject 406 from the first image 404. The second image of the subject 406 may be saved to the image repository, such as the photo app and/or a separate sticker library.

The electronic device 102 may then generate one or more tags for the second image, as described above with respect to FIG. 3. In some examples, when the electronic device 102 obtains the image or at any point thereafter, the electronic device 102 may generate one or more tags for the image, as described above with respect to FIG. 3. The generated tags may be saved on the electronic device 102.

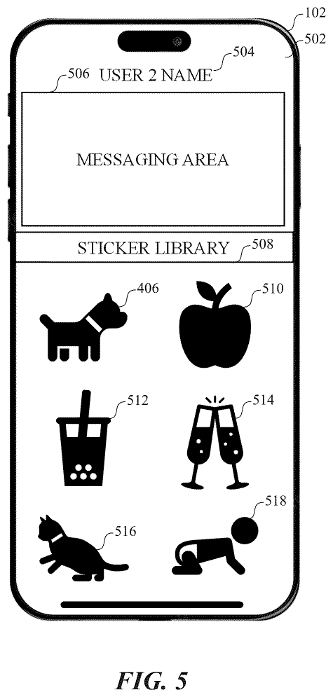

FIG. 5 depicts an electronic device displaying a set of digital stickers, in accordance with one or more implementations. For explanatory purposes, FIG. 5 is primarily described herein with reference to the electronic device 102 of FIG. 1. Not all of the depicted components may be used in all implementations, however, and one or more implementations may include additional or different components than those shown in the figure.

The electronic device 102 may include an image repository 302 including one or more images. The image repository 302 may be managed by and/or included in, an application on the electronic device 102, such as a sticker library. For example, as shown in FIG. 5, the sticker library 508 may include one or more digital stickers, such as the second image of the subject 406 from FIG. 4, and/or other stickers 510-518 that may have been extracted and/or segmented from another image or obtained (e.g., accessed, downloaded, received, and the like) directly as a sticker.

The electronic device 102 may execute an application, which may include text data. The application may be a messaging application 502 including a messaging area 506 for displaying text data such as a messaging transcript between a first user (e.g., the user of the electronic device 102) and a second user 504. The messaging area 506 may also or instead display image data such as one or more of the stickers from the sticker library. For example, the first user may tap on a sticker in the sticker library and cause the electronic device 102 to send the sticker to the second user 504 as a message and display in the messaging area 506.

In some examples, the sticker library 508 may include a search bar for the user to identify certain stickers. The search bar may be configured to receive text data (e.g., from the keyboard 312 of the electronic device). The suggestion engine 310 of the electronic device 102 may select one or more digital stickers stored in the sticker library based on the received text data in a manner described above with respect to FIG. 3 and provide the selected stickers for display. In this manner, the first user does not need to scroll through a potentially large library of stickers but may search for particular stickers.

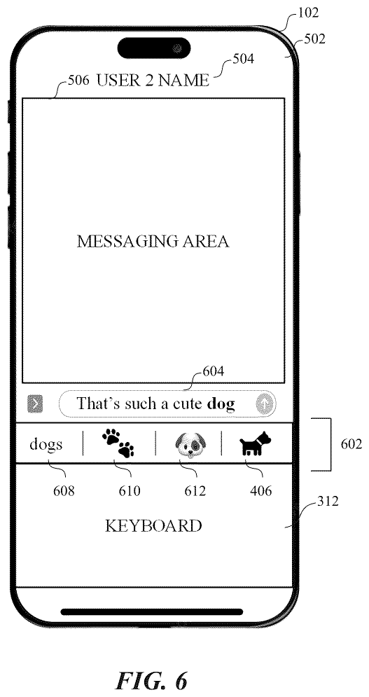

FIG. 6 depicts an electronic device displaying digital sticker suggestions, in accordance with one or more implementations. For explanatory purposes, FIG. 6 is primarily described herein with reference to the electronic device 102 of FIG. 1. Not all of the depicted components may be used in all implementations, however, and one or more implementations may include additional or different components than those shown in the figure.

The electronic device 102 may also provide a keyboard 312 for inputting text data. The user may type a message 604 to be sent to another user and displayed in the messaging area. As the user is typing or after the user has typed the message 604 on the keyboard 312, the suggestion engine 310 of the electronic device 102 may select one or more digital stickers stored in the sticker library based on the message 604 in a manner described above with respect to FIG. 3.

For example, as shown in FIG. 6, the first user types a message 604 to be sent the second user 504 saying, “That's such a cute dog.” The suggestion engine 310 on the electronic device 102 may receive the message 604 and obtain one or more digital stickers based on one or more words included in the message. Because the image repository 302 includes at least the sticker of the subject 406 that was tagged by the electronic device 102 with “dog,” a comparison of the message 604 and the semantic index 306 yields at least the identifier of the sticker of the subject 406. The suggestion engine 310 may use the identifier to retrieve the sticker of the subject 406 from the image repository 302.

After the electronic device 102 obtains the one or more digital stickers stored in the sticker library based on the message 604, the electronic device 102 may provide the selected stickers for display to the user. This way the user does not need to access another application to obtain a sticker from the sticker library.

For example, the keyboard 312 may be a predictive keyboard that includes suggestions in a suggestion area 602 for the user to add to the message. The electronic device 102 may present the sticker of the subject 406 to the user in the suggestion area 602 of the keyboard 312. The keyboard 312 may also suggest a word 608 to complete and/or correct the last word the user typed in the message 604 (e.g., “dog”). The keyboard 312 may also suggest emojis 610, 612 based on the last word the user typed in the message 604.

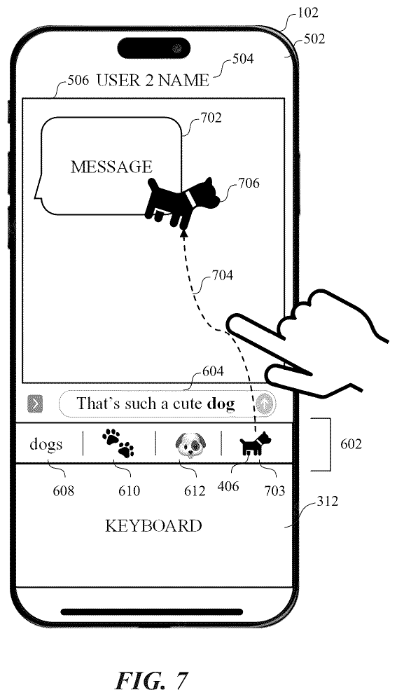

FIG. 7 depicts a user utilizing a digital sticker in a message transcript on an electronic device, in accordance with one or more implementations. For explanatory purposes, FIG. 7 is primarily described herein with reference to the electronic device 102 of FIG. 1. Not all of the depicted components may be used in all implementations, however, and one or more implementations may include additional or different components than those shown in the figure.

After the electronic device 102 provides the selected stickers for display to the user, the user may use the sticker such as by sending it as a message, attaching it to the message 604, or placing it in the messaging area 506 (e.g., a message transcript). For example, as shown in FIG. 7, the user peels the sticker of the subject 604 by touching the touchscreen (e.g., triggering a touch-down event on the touchscreen) at the first location 703, and the user sticks the sticker to a message 702 in the messaging area 506 by dragging 704 the sticker and releasing the sticker over the message 702 (e.g., triggering a drag and touch-up event on the touchscreen) at a second area 706.

After use of the sticker, the electronic device 102 may perform a contextual analysis of the sticker of the subject 406 as described above with respect to FIG. 3. For example, the electronic device 102 may review the content of the message 702 and/or any other messages in the messaging transcript to identifying features such as emotive words and phrases, the time of the message, the other participant(s) in the message transcript, and/or the application in which the sticker was used. The electronic device 102 generates auxiliary metadata for the sticker of the subject 406 based on the contextual analysis and stores the auxiliary metadata in the behavior index 318 to improve future recommendations.

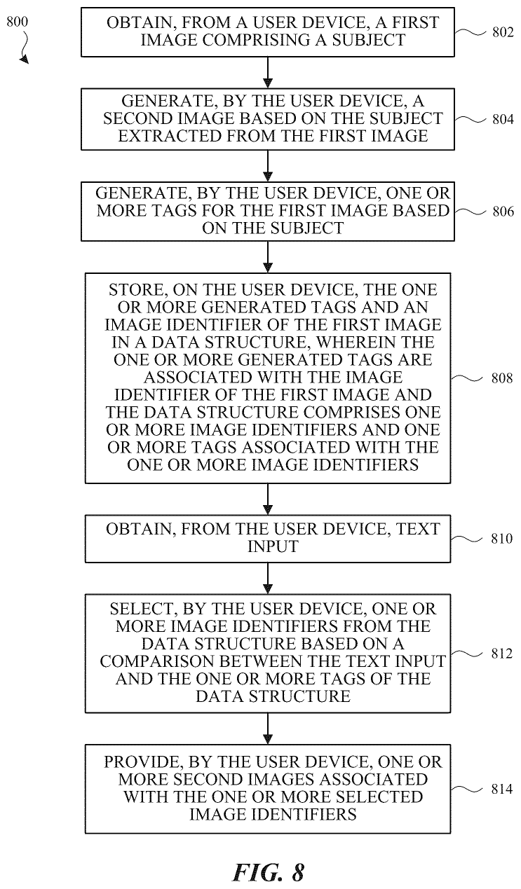

FIG. 8 depicts a flow diagram of an example process 800 for suggesting digital stickers, in accordance with one or more implementations. For explanatory purposes, the process 800 is primarily described herein with reference to the electronic device 102, the electronic device 104, and the server 108 of FIG. 1. However, the process 800 is not limited to the electronic device 102, the electronic device 104, or the server 108, and one or more blocks of the process 800 may be performed by one or more other components of the server 108, and/or by other suitable devices. Further, for explanatory purposes, the blocks of the process 800 are described herein as occurring sequentially or linearly. However, multiple blocks of the process 800 may occur in parallel. In addition, the blocks of the process 800 need not be performed in the order shown and/or one or more blocks of the process 800 need not be performed and/or can be replaced by other operations.

At block 802, the user device (e.g., the electronic device 102) obtains a first image that includes a subject. A first image (e.g., first image 404) may be a visual representation of a subject (e.g., subject 406) (e.g., object, scene, or graphical content), captured, created, or stored in electronic form by an imaging sensor (e.g., sensor 206). The first image can be acquired, downloaded, received, generated, or otherwise obtained through various approaches including optical sensors (e.g., sensor 206), scanners, and/or generated using computer graphics algorithms. The first image may be stored on the user device (e.g., at an image repository 302 in memory 204).

At block 804, the user device generates, a second image based on the subject extracted from the first image. A second image (e.g., a digital sticker) may be a digital representation derived from the first image, where the first image serves as a reference or source for extracting, and/or segmenting, a specific subject (e.g., the subject 406) or object. Subject extraction may involve identifying and isolating the desired object or subject within the first image, for instance, by utilizing techniques such as image segmentation, pattern recognition, or computer vision algorithms. The extracted subject may then be utilized as the foundation for generating the second image, which may be in the form of a digital sticker. As a digital sticker, the second image may retain the outline, shape, or distinctive features of the subject, while removing or replacing the background context (e.g., the background 402). This allows the second image to be easily placed or superimposed onto other digital content, such as messages, photographs, videos, or virtual environments, interactively the user. In one or more implementations, the subject 406 may be the entirety of the second image.

At block 806, the user device generates one or more tags for the second image based on the subject. The user device may automatically generate tags, which include descriptive labels and/or keywords that represent the subject of the second image. These tags may serve as metadata or annotations that may provide textual information about the content of the second image, aiding in the categorization and/or searchability of the images. The generation of the tags may be performed using machine learning techniques (e.g., computer vision models, natural language processing, or deep neural networks) in which the user device analyzes the visual characteristics, features, and/or patterns of the subject in the second image and applies computational models or algorithms to infer relevant semantic concepts or labels.

For example, if the subject is a slice of pizza, the generated tags may include terms such as “pizza” or “food,” or other relevant descriptors. These tags may help efficient organization, retrieval, and/or identification of the second image within digital collections, databases, and/or user interfaces, facilitating improved search functionality and suggestions.

In some examples, the user device may generate image embeddings as tags for the second image. The image embeddings may serve as representations of the visual content and characteristics of the subject, enabling fuzzy matching with text embeddings corresponding to search queries. The generation of image embeddings may include extracting high-level visual features and patterns from the second image, for example, by using deep learning architectures (e.g., convolutional neural networks) trained to capture and encode visual features (e.g., edges, textures, shapes, colors and the like) into numerical representations. Fuzzy matching enables a similarity-based search, where images whose tags (represented as image embeddings) closely align with the text embedding are identified as potential matches.

At block 808, the user device stores the one or more tags in a data structure in association with the second image. The one or more tags and the second image may be stored in one or more tables, databases, or any other data structures, where each entry may represent a unique image and its associated tags. The user device may assign a unique identifier, such as a numerical or alphanumeric code, to the second image. The identifier may serve as a key or index for obtaining the stored tags related to the associated image. The tags may be stored as data fields or columns within the data structure, allowing for easy organization and retrieval based on the identifier.

For example, consider a table (e.g., the semantic index 306) where each row represents an image, and the columns include an “image identifier” column and a “tags” column. The image identifier uniquely identifies the image (e.g., in the image repository 302), while the tags column stores the one or more tags associated with that image. The tags may be represented as strings, numbers, embeddings, or any other suitable format and may be stored in any suitable data structure.

At block 810, the user device obtains text input. The user device may acquire, receive, capture, or otherwise obtain text input from the user through an input device interface, including a physical keyboard, a virtual keyboard (e.g., keyboard 312) displayed on a touchscreen, voice recognition system, or other input modalities. The user may interact with the input interface, for example, by manually typing or dictating text, selecting from suggested options, and/or utilizing voice commands. In some examples, the text input may be obtained by the user device as the text input is being typed on a keyboard of the user device.

At block 812, the user device identifies, retrieves, or otherwise selects the second image based on a comparison between the text input and the one or more tags of the data structure. The data structure (e.g., the semantic index 306) may include information about the available images (e.g., in the image repository 302), including their corresponding tags. The user device may compare the text input (e.g., in the form of a search query or descriptive keywords) with the tags of the images in the data structure. The comparison may include various techniques, such as string matching, fuzzy matching, similarity scoring, or semantic analysis, which assess the degree of similarity or relevance between the text input and the tags associated with each image. Based on this comparison, the user device may select one or more images, such as the second image, whose tags exhibit above a threshold degree of similarity to the text input, such as based on a comparison between the tags and the text input.

For example, if a user enters the text input “beach” as a search query, the user device would compare this input with the tags stored in the data structure. Images with tags such as “beach,” “ocean,” “sand,” “sun,” “vacation,” or “coast” would likely receive higher similarity scores.

In some examples where the tags of an image include image embeddings, the user device may convert the text input to one or more text embeddings representing the content and meaning of the text input. The user device may then utilize fuzzy matching techniques to compare and match the image embeddings (representing the tags) of an image with the text embeddings of the text input in an embedding space. This enables a similarity-based search, where images whose embeddings closely align (e.g., are within a threshold distance (e.g., Euclidian distance) in the embedding space) with the text embedding may be identified as potential matches.

For example, if the user inputs “pizza,” the user device would generate a text embedding for “pizza” and compare it with the image embeddings stored in the data structure. By employing fuzzy matching, the system can identify digital stickers whose image embeddings closely resemble the text embedding, suggesting relevant images associated with “pizza” or related concepts (e.g., pasta or other food items).

At block 814, the user device provides the second image, in response to obtaining the text input. The user device may save, transmit, display, output, or otherwise provide the selected second image. For example, the user device may display the second image on a screen of the user device, allowing the user to preview, manipulate, or use the image as desired.

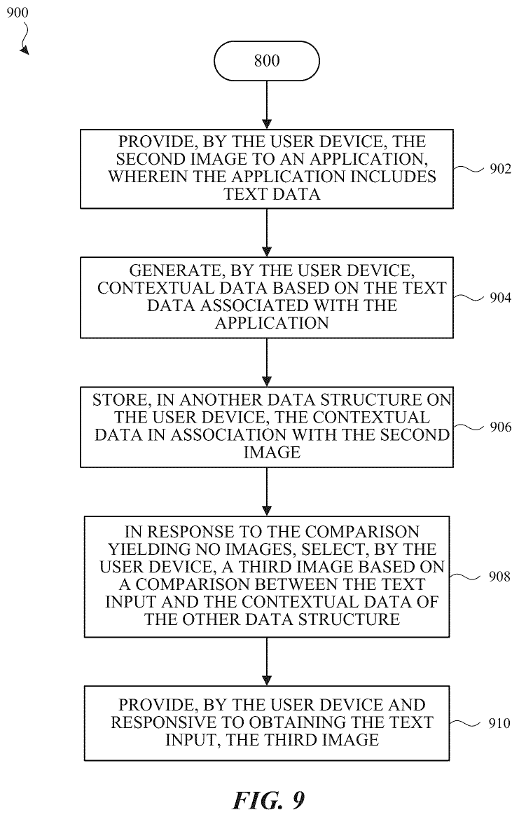

FIG. 9 depicts a flow diagram of another example process 900 for suggesting digital stickers, in accordance with one or more implementations. For explanatory purposes, the process 900 is primarily described herein with reference to the electronic device 102, the electronic device 104, and the server 108 of FIG. 1. However, the process 900 is not limited to the electronic device 102, the electronic device 104, or the server 108, and one or more blocks of the process 900 may be performed by one or more other components of the server 108, and/or by other suitable devices. Further, for explanatory purposes, the blocks of the process 900 are described herein as occurring sequentially or linearly. However, multiple blocks of the process 900 may occur in parallel. In addition, the blocks of the process 900 need not be performed in the order shown and/or one or more blocks of the process 900 need not be performed and/or can be replaced by other operations. The process 900 may be performed in addition to or instead of performing blocks 804, 806, 808, 812 of the process 800.

At block 902, the user device provides the second image to an application (e.g., messaging application 502). The user device (e.g., electronic device 102) may facilitate the transfer and/or integration of the second image from storage or display to an application. The user device may coordinate the transfer and/or integration, ensuring that the application receives the appropriate image data and associated metadata, such as the visual content, size, position, and any additional customization or formatting attributes of the second image. In one or more implementations, the second image may be provided to the application via an inter-process communication such that the application can only access stickers for which the user has selected for use within the application.

For example, when using a messaging application, the user may select a digital sticker (e.g., the second image) by interacting with the user device and dragging the sticker from a sticker library or collection (e.g., as shown in FIG. 7). The user device may recognize the dragging action and provide the image to the messaging application (e.g., the messaging application 502) in real-time, allowing the user to visually position and place the sticker (e.g., on a message or conversation) within the application's interface.

At block 904, the user device generates contextual data based on the text data associated with the application. Text data associated with the application may include various forms of textual content, such as notes in a note-taking application or messages in a messaging application. The contextual data may include keywords in the text data (e.g., emotive words), the application, the time of day, other associated users (e.g., the other party to a conversation in a messaging application), and any other metadata.

In some examples, the user device identifies and/or generates relevant contextual words by comparing the associated text data with a predetermined word list that maps to emojis, which may provide a basis for relevant emotive words. The process may begin by analyzing the associated text data, which can include content from various sources, such as notes, messages, or other textual elements within an application. The user device may compare this text data with a predetermined word list that includes words corresponding to emojis. The predetermined word list may act as a mapping between words and emojis, where each word is associated with one or more emojis that convey a particular meaning, sentiment, or concept. The user device may perform a comparison between the text data and the words in the predetermined list, identifying matches or similarities between the two. Based on this comparison, the user device may generate one or more contextual words that capture the essence or context of the associated text data. These contextual words may serve as representations of the underlying emotions, topics, sentiments, or concepts expressed within the text data, as indicated by the corresponding emojis in the predetermined word list.

For example, a list of emojis may include “smiling face” emoji and a predetermined list of one or more words that describe the emoji, such as “happy,” “smiling,” “cheerful,” and the like. If the text data includes the word “happy” and the predetermined word list includes “happy,” the user device would generate the contextual word “happy” based on this comparison. Similarly, if the text data contains the word “love” and the predetermined word list that includes “love” (e.g., based on the “heart” emoji), the user device would generate the contextual word “love.”

In some examples, the user device utilizes text embeddings to generate contextual data (e.g., contextual embeddings). A text embedding may include a numerical representation of textual content (e.g., a vector derived from deep learning models or natural language processing techniques). Text embeddings capture the semantic meaning and relationships of the associated text data in a vector space, allowing for fuzzy comparisons. For example, the user device may generate text embeddings for some or all of the text data associated with the application and use the resulting text embeddings as at least part of the contextual data. The contextual data may also include other relevant contextual words by selecting other words or phrases within a threshold distance (e.g., in an embedding space) from the text embeddings of the text data.

At block 906, the user device stores the contextual data. The user device stores the contextual data in a data structure in association with the second image. The contextual data and the second image may be stored in one or more tables, databases, or any other data structures, where each entry may represent a unique image and its associated contextual data. The user device may assign a unique identifier, such as a numerical or alphanumeric code, to the second image. The identifier may serve as a key or index for accessing and retrieving the stored contextual data related to the associated image. The contextual data may be stored as data fields or columns within the data structure, allowing for easy organization and retrieval based on the identifier.

For example, consider a table (e.g., the behavior index 318) where each row represents an image and the columns include an “image identifier” column and a “contextual data” column. The image identifier uniquely identifies the image (e.g., in the image repository 302), while the contextual data column stores the one or more contextual data associated with that image. The contextual data may be represented as strings, numbers, embeddings, or any other suitable format.

At block 908, the user device identifies, retrieves, or otherwise selects a third image based on a comparison between the text input and the contextual data of the other data structure. The other data structure (e.g., the behavior index 318) may contains information about the available images (e.g., in the image repository 302), including their corresponding contextual data. The user device may compare the text input (e.g., in the form of a search query or descriptive keywords) with the contextual data of the images in the other data structure. The comparison may include various techniques, such as string matching, fuzzy matching, similarity scoring, or semantic analysis, which assess the degree of similarity or relevance between the text input and the contextual data associated with each image. Based on this comparison, the user device may select one or more images, such as the second image, which exhibit above a threshold degree of similarity to the text input.

For example, if a user enters the text input “beach” as a search query, the user device would compare this input with the contextual stored in the data structure. Images with contextual data including words such as “beach,” “ocean,” “sand,” “sun,” “vacation,” or “coast” would likely receive higher similarity scores, where such words were used in one or more previous usages of the images (e.g., the image was used as a sticker on a note in a note application discussing destination holiday plans).

In some examples, the contextual data may include text embeddings, and the user device may convert the text input to text embeddings representing the content and meaning of the text input. The user device may then utilize fuzzy matching techniques to compare and match the text embeddings of the contextual data of an image with the text embeddings of the text input. This enables a similarity-based search, where images whose embeddings closely align (e.g., are within a threshold distance (e.g., Euclidian distance) in an embedding space) with the text embedding may be identified as potential matches.

For example, if an image was previously used a digital sticker in a message about food in a messaging application, the contextual data of the image may include a text embedding of the word “food” and/or other relevant phrases. If the user inputs “pizza,” the user device would generate a text embedding for the word “pizza” and compare it with text embeddings of the contextual data stored in the data structure. By employing fuzzy matching, the system can identify digital stickers whose contextual data closely resemble the text embedding, suggesting relevant images associated with “pizza” or related concepts (e.g., food).

In some examples, block 908 may be performed in response to the comparison of block 812 yielding no images.

At block 910, providing, by the user device and responsive to obtaining the text input, the third image. The third image may be provided in a manner similar to the second image in block 814.

FIG. 10 depicts an example electronic system 1000 with which aspects of the present disclosure may be implemented, in accordance with one or more implementations. The electronic system 1000 can be, and/or can be a part of, any electronic device for generating the features and processes described in reference to FIGS. 1-9, including but not limited to a laptop computer, tablet computer, smartphone, and wearable device (e.g., smartwatch, fitness band). The electronic system 1000 may include various types of computer-readable media and interfaces for various other types of computer-readable media. The electronic system 1000 includes one or more processing unit(s) 1014, a persistent storage device 1002, a system memory 1004 (and/or buffer), an input device interface 1006, an output device interface 1008, a bus 1010, a ROM 1012, one or more processing unit(s) 1014, one or more network interface(s) 1016, one or more sensors 1018, and/or subsets and variations thereof.

The bus 1010 collectively represents all system, peripheral, and chipset buses that communicatively connect the numerous internal devices of the electronic system 1000. In one or more implementations, the bus 1010 communicatively connects the one or more processing unit(s) 1014 with the ROM 1012, the system memory 1004, and the persistent storage device 1002. From these various memory units, the one or more processing unit(s) 1014 retrieves instructions to execute and data to process in order to execute the processes of the subject disclosure. The one or more processing unit(s) 1014 can be a single processor or a multi-core processor in different implementations.

The ROM 1012 stores static data and instructions that are needed by the one or more processing unit(s) 1014 and other modules of the electronic system 1000. The persistent storage device 1002, on the other hand, may be a read-and-write memory device. The persistent storage device 1002 may be a non-volatile memory unit that stores instructions and data even when the electronic system 1000 is off. In one or more implementations, a mass-storage device (such as a magnetic or optical disk and its corresponding disk drive) may be used as the persistent storage device 1002.

In one or more implementations, a removable storage device (such as a flash drive) may be used as the persistent storage device 1002. Like the persistent storage device 1002, the system memory 1004 may be a read-and-write memory device. However, unlike the persistent storage device 1002, the system memory 1004 may be a volatile read-and-write memory, such as RAM. The system memory 1004 may store any of the instructions and data that one or more processing unit(s) 1014 may need at runtime. In one or more implementations, the processes of the subject disclosure are stored in the system memory 1004, the persistent storage device 1002, and/or the ROM 1012. From these various memory units, the one or more processing unit(s) 1014 retrieves instructions to execute and data to process in order to execute the processes of one or more implementations.

The bus 1010 also connects to the input device interfaces 1006 and output device interfaces 1008. The input device interface 1006 enables a user to communicate information and select commands to the electronic system 1000. Input devices that may be used with the input device interface 1006 may include, for example, alphanumeric keyboards, touch screens, and pointing devices. The output device interface 1008 may enable the electronic system 1000 to communicate information to users. For example, the output device interface 1008 may provide the display of images generated by electronic system 1000. Output devices that may be used with the output device interface 1008 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 1010 also connects to sensor(s) 1018. The sensor(s) 1018 may include a location sensor, which may be used in determining device position based on positioning technology. For example, the location sensor may provide for one or more of GNSS positioning, wireless access point positioning, cellular phone signal positioning, Bluetooth signal positioning, image recognition positioning, and/or an INS (e.g., via motion sensors such as an accelerometer and/or gyroscope). In one or more implementations, the sensor(s) 1018 may be utilized to detect movement, travel, and orientation of the electronic system 1000. For example, the sensor(s) may include an accelerometer, a rate gyroscope, and/or other motion-based sensor(s).

Finally, as shown in FIG. 10, the bus 1010 also couples the electronic system 1000 to one or more networks and/or to one or more network nodes through the one or more network interface(s) 1016. In this manner, the electronic system 1000 can be a part of a network of computers (such as a local area network, a wide area network, an Intranet, or a network of networks, such as the Internet). Any or all components of the electronic system 1000 can be used in conjunction with the subject disclosure.

Implementations within the scope of the present disclosure can be partially or entirely realized using a tangible computer-readable storage medium (or multiple tangible computer-readable storage media of one or more types) encoding one or more computer-readable instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As described above, one aspect of the present technology is the gathering and use of data available from specific and legitimate sources for file sharing. The present disclosure contemplates that in some instances, this gathered data may include personal information data that uniquely identifies or can be used to identify a specific person. Such personal information data can include demographic data, location-based data, online identifiers, telephone numbers, email addresses, home addresses, images, videos, audio data, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, personal information data can be used for file sharing. Accordingly, the use of such personal information data may facilitate transactions (e.g., online transactions). Further, other uses for personal information data that benefit the user are also contemplated by the present disclosure. For instance, health and fitness data may be used, in accordance with the user's preferences to provide insights into their general wellness or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of file sharing, the present technology can be configured to allow users to select to “opt-in” or “opt-out” of participation in the collection of personal information data during registration for services or anytime thereafter. In addition to providing “opt-in” and “opt-out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed implementations, the present disclosure also contemplates that the various implementations can also be implemented without the need for accessing such personal information data. That is, the various implementations of the present technology are not rendered inoperable due to the lack of all or a portion of such personal information data.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
obtaining, from a user device, a first image comprising a subject;
generating, by the user device, a second image based on the subject extracted from the first image;
generating, by the user device, one or more tags for the second image based on the subject, wherein the one or more tags represent the subject;
storing, in a data structure on the user device, the one or more tags in association with the second image;
obtaining, from the user device, text input;
selecting, by the user device, the second image based on a comparison between the text input and the one or more tags of the data structure; and
providing, by the user device and responsive to obtaining the text input, the second image.

2. The method of claim 1, wherein the second image is a user-placeable digital sticker.

3. The method of claim 1, wherein obtaining the text input from the user device comprises receiving the text input from the user device as the text input is being typed on a keyboard of the user device.

4. The method of claim 1, wherein generating the one or more tags for the second image comprises:
generating, by a computer vision model, one or more words that describe the second image.

5. The method of claim 1, wherein the one or more tags of the data structure comprises one or more image embeddings, the text input corresponds to a text embedding, and the comparison comprises determining a distance between the one or more tags of the data structure and the text embedding in an embedding space.

6. The method of claim 1, further comprising:
providing, by the user device, the second image to an application, wherein the application includes text data;
generating, by the user device, contextual data based on the text data associated with the application; and
storing, in another data structure on the user device, the contextual data in association with the second image.

7. The method of claim 6, further comprising, in response to the comparison yielding no images:
selecting, by the user device, a third image based on a comparison between the text input and the contextual data of the other data structure; and
providing, by the user device and responsive to obtaining the text input, the third image.

8. The method of claim 6, wherein generating the contextual data comprises generating one or more contextual words based on a comparison between at least some of the associated text data and a predetermined word list comprising one or more words corresponding to one or more emojis.

9. The method of claim 6, wherein the text data corresponds to a text embedding and wherein generating the contextual data comprises selecting one or more contextual words associated with contextual embeddings that are within a threshold distance from the text embedding.

10. The method of claim 6, wherein providing the second image to the application comprises:
receiving, by the user device, a touch-down input on a first area of an electronic display associated with the second image;
receiving, by the user device, a touch-up input on a second area of the electronic display associated with a message transcript; and
adding, by the user device, the second image to the message transcript, in response to receiving the touch-up input.

11. A non-transitory computer-readable medium storing instructions that, when executed by a processor, causes the processor to perform operations comprising:
obtaining, by a user device, text input;
selecting, by the user device, an image based on a comparison between the text input and a tag associated with the image, the tag having been derived from at least one of the image or a prior use of the image, and the image having been extracted from another image; and
providing, by the user device and responsive to obtaining the text input, the image.

12. The non-transitory computer-readable medium of claim 11, wherein the image is a user-placeable digital sticker.

13. The non-transitory computer-readable medium of claim 11, wherein obtaining the text input comprises receiving the text input from the user device as the text input is being typed on a keyboard of the user device.

14. The non-transitory computer-readable medium of claim 11, wherein the tag represents a subject of the image.

15. The non-transitory computer-readable medium of claim 14, wherein the instructions cause the processor to perform operations further comprising deriving the tag by generating, with a computer vision model, one or more words that describe the subject of the image.

16. The non-transitory computer-readable medium of claim 11, wherein the tag comprises an image embedding, the text input comprises a text embedding, and the comparison comprises determining a distance between the tag and the text embedding in an embedding space.

17. The non-transitory computer-readable medium of claim 11, wherein the instructions cause the processor to perform operations further comprising deriving the tag by using the image in an application, wherein the usage comprises text data associated with the application.

18. The non-transitory computer-readable medium of claim 17, wherein the text data associated with the application comprises one or more words corresponding to one or more emojis.

19. The non-transitory computer-readable medium of claim 17, wherein the text data associated with the application comprises a text embedding.

20. The non-transitory computer-readable medium of claim 17, wherein using the image in the application comprises:
receiving, by the user device, a touch-down input on a first area of an electronic display associated with the image;
receiving, by the user device, a touch-up input on a second area of the electronic display associated with a message transcript of the application; and
adding, by the user device, the image to the message transcript, in response to receiving the touch-up input.

21. A device comprising:
a processor configured to:
generate one or more tags for an image of a subject, wherein the one or more tags represent the subject, and the image of the subject having been extracted from another image;
store, in a data structure on the device, the one or more tags in association with the image;
obtain text input;
select the image based on a comparison between the text input and the one or more tags of the data structure; and
provide, responsive to obtaining the text input, the image.
